(19) United States
(12) Patent Application Publication
(10) Pub. No.: US 2008/0007217 A1
(43) Pub. Date: Jan. 10, 2008

(54) METHOD AND APPARATUS FOR RECHARGING A HEARING DEVICE

(76) Inventor: Louis F. Riley, Weston, FL (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/622,106

(22) Filed: Jan. 11, 2007

Related U.S. Application Data
(60) Provisional application No. 60/866,081, filed on Nov. 16, 2006.
(60) Provisional application No. 60/806,633, filed on Jul. 6, 2006.

(51) Int. Cl. H02J 7/00

(52) U.S. Cl. 320/115

(57) ABSTRACT

A method and apparatus for recharging a hearing device. The method includes providing a hearing device and a charging device wherein each has a charging element. The method then involves inserting the hearing device into the charging device such that the first and second charging elements interact to recharge the hearing device.

### CROSS REFERENCE TO RELATED APPLICATION

This application claims the benefit of U.S. Provisional Application Nos. 60/866,081 filed Nov. 16, 2006 and 60/806,633 filed Jul. 6, 2006.

### BACKGROUND OF THE INVENTION

This invention is directed toward a rechargeable hearing device and charging receptacle. Rechargeable hearing devices are known in the art. These devices are not aesthetically appealing nor are they easy to use and recharge. Thus, there is a need for a hearing device and charger that address these deficiencies.

Thus, a principal object of the present invention is to provide an improved method of recharging a hearing device that facilitates use.

These and other objects, features, or advantages of the present invention will become apparent from the specification and claims.

### BRIEF SUMMARY OF THE INVENTION

An improved method for recharging a hearing device. The steps include providing a hearing device that has a main body with an earphone thereon and a first charging element. The next step involves providing a charging device that has a receptacle therein that has a second charging element. The method is completed by inserting the hearing device into the receptacle of the charging device such that the first and second charging elements interact with one another to recharge the hearing device.

### BRIEF DESCRIPTION OF THE DRAWINGS

FIG. 1 is a perspective view of a hearing device within a charging device;

FIG. 2 is a perspective view of a charging device;

FIG. 3 is a perspective view of a charging device;

FIG. 4 is a front plan view of a hearing device;

FIG. 5 is a side plan view of a hearing device;

FIG. 6 is a back plan view of a hearing device; and

FIG. 7 is an elevation view of a hearing device in combination with a charging device.

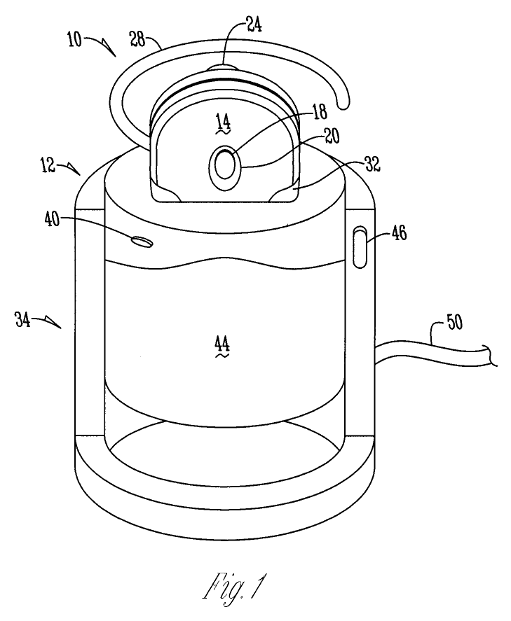

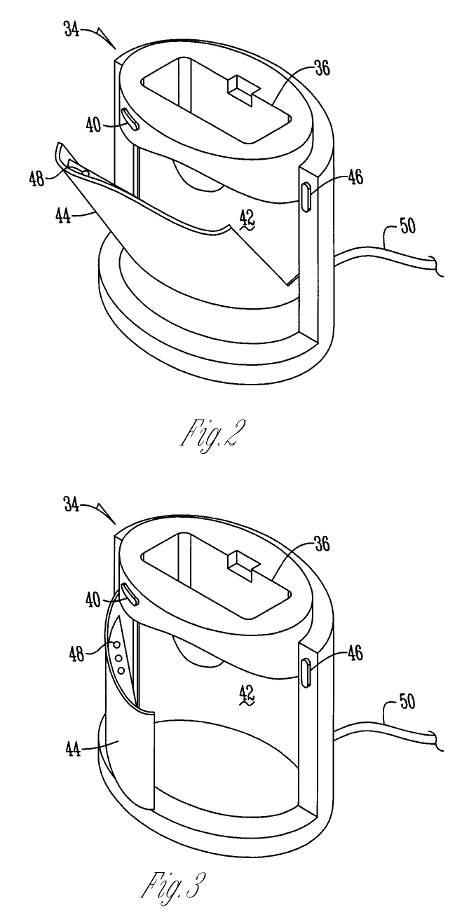

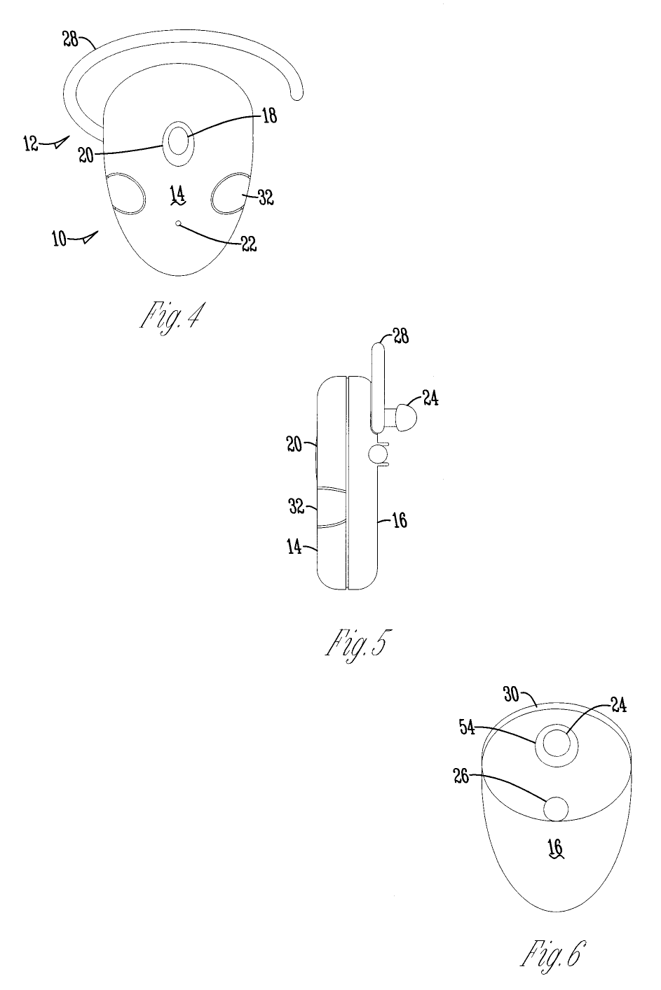

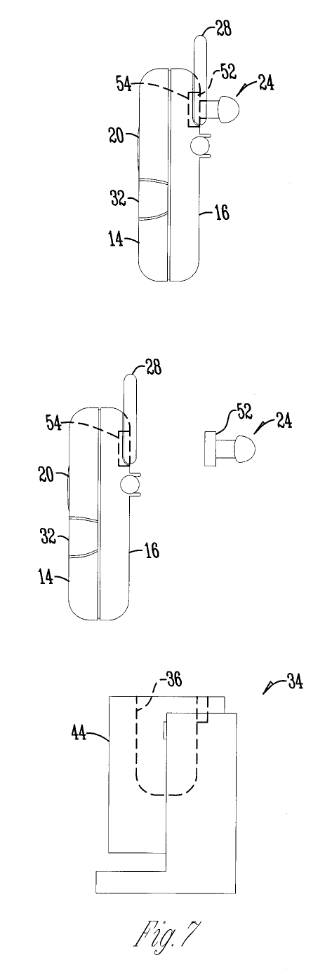

### DETAILED DESCRIPTION OF THE PREFERRED EMBODIMENT

The hearing device 10 has a main body 12 having a front and back panels 14 and 16. Preferably, the main body 12 has a tear-drop shape. Mounted on the front panel 14 is an on/off switch 18, a power indicator LED 20, and an MIC 22 (microphone). The power indicator LED 20 has a plurality of colors to indicate different operating states. For example, green could mean normal, red could mean low power, and yellow could mean charging.

Mounted on the back panel 16 is an earphone 24 and a hook holder 26. The earphone 24 is formed to receive an ear cushion and is positioned to fit within the ear canal. The hook holder 26 is formed to receive a hook 28 that fits over the ear.

Mounted at one end of the main body 12 and between the front and the back panel is a rotatable volume dial 30. Mounted to the sides of the main body 12 are a pair of charge plates and/or ports 32.

The hearing device 10 is formed to be matingly received within a charging device 34. The charging device 34 has a receptacle 36 formed therein with a pair of charge plates and/or prongs 38 that align with the charge plates 32 on the hearing device when the hearing device is inserted within the charging receptacle 36. Mounted on the exterior of the charging device 34 is an indicator LED 40 that indicates the operational state of that charging device 34. For example, when the indicator LED 40 is yellow, this would indicate a charging state and when the indicator LED 40 is green this would indicate the power is on.

The charging device 34 has a storage chamber 42 that is enclosed by a door 44 that is hingedly connected to the charging device 34. A release button 46 is mounted on the charging device 34 such that when engaged the door 44 is released allowing access to the storage chamber 42. The storage chamber 42 is for holding hearing device equipment such as ear cushions, a cleaning broom, and the like. In one embodiment the door 44 has sub-chambers 48 formed to receive the hearing device equipment. The charging device 34 has a power cord 50 that connects with a power supply.

In an alternative embodiment the earphone 24 is detachable from the main body 12 of the hearing device 10. Specifically, the earphone 24 comprises a positive battery contact plate 52 at its base that contacts a similar negative battery contact plate 54 within the main body 12 of the hearing device 10 when the two separate pieces are attached together. Upon contact of the positive and negative battery contact plates 52 and 54 the earphone 24 can be recharged. Thus, an individual using the hearing device has the choice of placing the entire hearing device 10 including the main body 10 with the hook 28 and earphone 24 attached therein into their ear or they may remove the earphone piece from the main body 12 and place only the earphone 24 within their ear. In this embodiment the charging device is designed to accommodate the two-piece hearing device.

It will be appreciated by those skilled in the art that other various modifications could be made to the device without the parting from the spirit in scope of this invention. All such modifications and changes fall within the scope of the claims and are intended to be covered thereby.

What is claimed is:

1. A method of recharging a hearing device steps comprising:
providing a hearing device having a main body with an earphone therein and a first recharging element;
providing a charging device having a receptacle therein and a second charging element; and
inserting the hearing device into the receptacle of the charging device such that the first and second charging elements interact to recharge the hearing device.

2. The method of claim 1 wherein the first and second charging elements are charge plates.

3. The method of claim 1 wherein the first charging element is a charge port and the second charging element is a charge prong.

4. The method of claim 1 wherein the hearing device is matingly received with the charging device.

5. The method of claim 1 wherein the earphone is detachable from the main body of the hearing device.

6. The method of claim 5 wherein the earphone has a charge plate that associates with a charge plate of the main body when the earphone is attached to the main body.

7. The method of claim 1 wherein the charging device has a storage chamber enclosed by a door hingedly connected to the charging device.

8. The method of claim 7 wherein further comprising a release button mounted on the charging device such that when engaged the door is released allowing access to the storage chamber.

9. The method of claim 7 wherein the door has subchambers formed to receive hearing equipment.

10. The method of claim 1 wherein an indicator LED is mounted on the charging device to indicate an operational state of the charging device.

11. The method of claim 1 wherein the main body of the hearing device has front and back panels wherein an on/off switch is mounted to the front panel.

12. The method of claim 11 wherein a power indicator LED is mounted on the front panel.

13. A hearing device recharging assembly comprising:
a hearing device having a main body with an earphone therein and a first charging element;
a charging device having a receptacle therein and a second charging element; and
wherein the charging device matingly receives the hearing device such that the first and second charging elements interact.

14. The assembly of claim 13 wherein the earphone is detachable from the main body of the hearing device.

15. The assembly of claim 14 wherein the earphone has a charge plate that associates with a charge plate of the main body when the earphone is attached to the main body.

16. The assembly of claim 13 wherein the charging device has a storage chamber enclosed by a door hingedly connected to the charging device.

17. The assembly of claim 16 wherein further comprising a release button mounted on the charging device such that when engaged the door is released allowing access to the storage chamber.

18. The assembly of claim 13 wherein an indicator LED is mounted on the charging device to indicate an operational state of the charging device.
